(19) United States
(12) Patent Application Publication
(10) Pub. No.: US 2003/0187941 A1
(43) Pub. Date: Oct. 2, 2003

(54) Mail server, e-mail system and terminal

(76) Inventor: Fuminori Suzuki, Tokyo (JP)

Correspondence Address: EDWARDS & ANGELL, LLP, P.O. BOX 9169, BOSTON, MA, 02209, US

(21) Appl. No.: 10/383,402

(22) Filed: Mar. 6, 2003

(30) Foreign Application Priority Data
Mar. 6, 2002 (JP) 2002-060270

(51) Int. Cl. G06F 15/16

(52) U.S. Cl. 709/206; 709/203

(57) ABSTRACT

There is provided a mail server 10 which processes the received e-mail based on the source address. The mail server 10, which transmits e-mail to a terminal, includes a second storing unit 130 which stores the e-mail, a first storing unit 140 which stores a different e-mail from the e-mail stored in the second storing unit 130, an address storing unit 120 which stores mail addresses, a communication unit 100 which receives the e-mail from the outside through a communication network, a judging unit 102 which determines whether a source address of the e-mail received by the communication unit 100 from the outside is included in the mail addresses stored in the address storing unit 120, a received mail classification unit 110 which stores the e-mail in the second storing unit 130, in a case where the source address of the e-mail is included in the mail addresses stored in the address storing unit 120, and stores the e-mail in the first storing unit 140, in a case where the source address of the e-mail is not included in the mail addresses stored in the address storing unit 120, and a transmitting unit 150 which transmits a part of the e-mail to the terminal, in a case where the source address of the e-mail classified by the received mail classification unit 110 is not included in the mail addresses.

This patent application claims priority from a Japanese patent application No. 2002-060270 filed on Mar. 6, 2002, the contents of which are incorporated herein by reference.

### BACKGROUND OF THE INVENTION

1. Field of the Invention

The present invention relates to a mail server, an e-mail system and a terminal. More particularly, the present invention relates to a mail server, an e-mail system and a terminal which process e-mails received from the outside.

2. Description of the Related Art

In recent years, an e-mail system spreads and the number of e-mails received by a terminal is increasing. The increase in the number of e-mails gives a heavy load on the terminal which receives e-mails. To solve this problem, Japanese patent application publication No. 2001-94589 discloses an e-mail system which processes e-mails based on instruction from a client.

However, due to the increase in the number of e-mails, it is demanded to lighten the load on the terminal which receives e-mails.

### SUMMARY OF THE INVENTION

Therefore, it is an object of the present invention to provide a mail server, an e-mail system and a terminal which can solve the foregoing problem. The above and other objects can be achieved by combinations described in the independent claims. The dependent claims define further advantageous and exemplary combinations of the present invention.

According to the first aspect of the present invention, there is provided a mail server which transmits e-mail to a terminal. The mail server includes a communication unit which receives e-mail from the outside through a communication network, a first storing unit which stores the e-mail, a transmitting unit which transmits a part of the e-mail stored in the first storing unit to the terminal, which is the destination of the e-mail, a receiving unit which receives an instruction information indicating whether whole part of the e-mail, a part of which is transmitted to the terminal by the transmitting unit, is to be transmitted or to be deleted, and an e-mail processing unit which transmits or deletes the e-mail stored in the e-mail storing unit based on the instruction information in a case where the receiving unit receives the instruction information from the terminal.

According to the second aspect of the present invention, there is provided a mail server which transmits e-mail to a terminal. The mail server includes an address storing unit which stores a part of or whole part of mail addresses, a communication unit which receives e-mail from the outside through a communication network, a first storing unit which stores the e-mail, a judging unit which determines whether a source address of the e-mail received by the communication unit from the outside is included in the mail addresses stored in the address storing unit, and a received mail classification unit which stores the e-mail, of which the source address is not included in the mail addresses stored in the address storing unit, in the first storing unit. The transmitting unit transmits a part of the e-mail, of which the source address classified by the received mail classification unit is not included in the mail addresses, to the terminal which is a destination of the e-mail.

The transmitting unit may transmit a part of the e-mail to the terminal in a case where the number of the e-mails stored in the first storing unit becomes more than predetermined value, or a predetermined period has elapsed after the e-mail was stored in the first storing unit. The transmitting unit may transmit a source address of the e-mail to the terminal as a part of the e-mail, and the e-mail processing unit may transmit whole part of the e-mail, a part of which is transmitted to the terminal by the transmitting unit, to the terminal, or may delete the e-mail, based on the instruction information, in a case where the receiving unit receives instruction information from the terminal, the instruction information indicating that the e-mail, which includes the source address transmitted by the transmitting unit, is to be transmitted or to be deleted. The mail server may further include an e-mail composition unit which composes an undeliverable message which indicates that a destination address of the terminal does not exist, for a source terminal which is a source of the e-mail in a case where the receiving unit receives the instruction information, which indicates that the e-mail is to be deleted, from the terminal. The communication unit may transmit the undeliverable message to the source terminal by e-mail.

The mail server may include a receiving unit which receives the instruction information from the terminal, the instruction information indicating whether whole part of the e-mail, a part of which is transmitted by the transmitting unit, is to be transmitted or to be deleted, and an e-mail processing unit which transmits whole part of the e-mail, a part of which is transmitted by the transmitting unit, to the terminal, or deletes the e-mail, based on the instruction information received by the receiving unit.

The summary of the invention does not necessarily describe all necessary features of the present invention. The present invention may also be a sub-combination of the features described above.

### BRIEF DESCRIPTION OF THE DRAWINGS

FIG. 1 is a schematic diagram showing an entire mail administration system.

FIG. 2 is a block diagram showing the functional configuration of a mail server.

FIG. 3 is a block diagram showing the functional configuration of a destination terminal.

FIG. 4 is a flow chart indicating operation of the mail server.

FIG. 5 is a flow chart indicating operation of the mail server.

FIG. 6 is a flow chart indicating operation of the mail server.

FIG. 7 is a flow chart indicating operation of the mail server.

FIG. 8 is an example of a screen of a display of the destination terminal.

FIG. 9 is an example of contents of information when a conventional mail server transmits a plurality of e-mails to a terminal.

FIG. 10 is an example of contents of information when the mail server in this embodiment transmits a plurality of e-mails collectively to the terminal.

FIG. 11 is a block diagram showing a hardware configuration of the mail server.

FIG. 12 is a block diagram showing a hardware configuration of the destination terminal.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

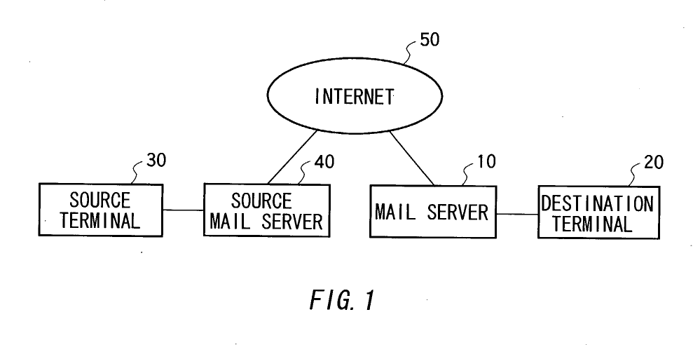

FIG. 1 is a schematic diagram showing an entire mail administration system according to the present embodiment. The mail administration system includes a mail server 10, a destination terminal 20, a source terminal 30, a source mail server 40, and the Internet 50.

The mail server 10 receives e-mail from the source terminal 30 through the source mail server 40 and the Internet 50. The mail server 10 transmits the e-mail received from the source terminal 30 to the destination terminal 20 which has the destination address of the e-mail.

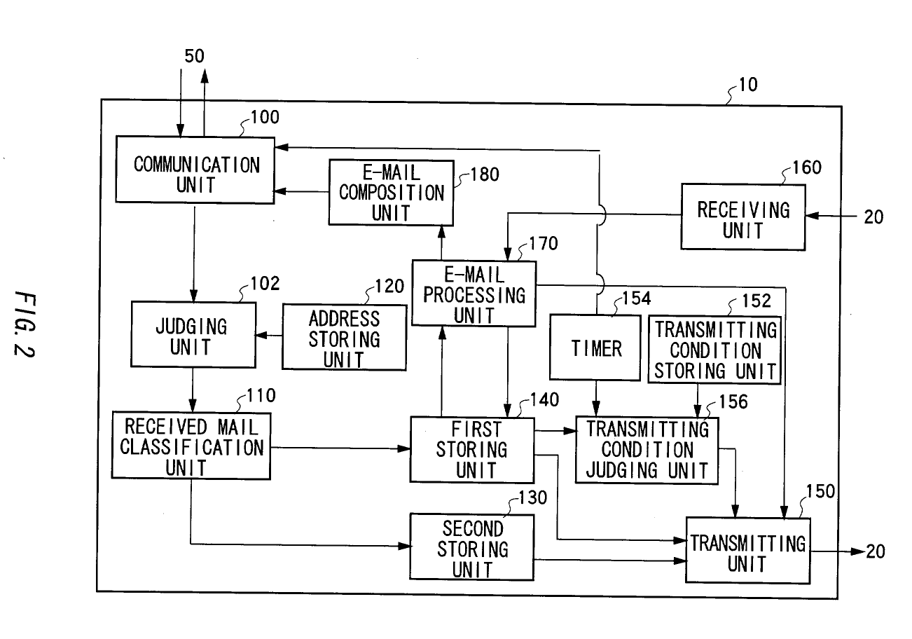

FIG. 2 is a block diagram showing the functional configuration of the mail server 10 according to the present embodiment. The mail server 10 of this embodiment classifies the received e-mails based on the source address of the e-mails, and transmits the classified e-mails to the destination terminal 20.

The mail server 10 includes a communication unit 100, a judging unit 102, a received mail classification unit 110, an address storing unit 120, a first storing unit 140, a second storing unit 130, a transmitting unit 150, a transmitting condition storing unit 152, a timer 154, a transmitting condition judging unit 156, a receiving unit 160, an e-mail processing unit 170, and an e-mail composition unit 180.

The address storing unit 120 stores the e-mail addresses. The address storing unit 120 stores transmitting permission addresses and the receive-refusing mail addresses. Complete sentence of e-mail from a source address which is included in the transmitting permission addresses is transmitted to the destination terminal 20, without waiting for instructions of the destination terminal 20. E-mail from a source address which is included in the receive-refusing mail addresses is deleted without waiting for instructions of the destination terminal 20. The first storing unit 140 stores the e-mails from the source addresses which are not included in the transmitting permission addresses stored in the address storing unit 120. The second storing unit 130 stores the e-mails from the source addresses which are included in the transmitting permission addresses stored in the address storing unit 120. The transmitting condition storing unit 152 stores information which indicates the transmitting conditions for transmitting the e-mails stored in the first storing unit 140 to the destination terminal 20. Specifically, the transmitting condition storing unit 152 stores count condition information which indicates the number of e-mails, and time condition information which indicates the time which has elapsed after the mail server 10 received each of the e-mail.

The communication unit 100 receives the e-mail from the source terminal 30 through the source mail server 40 and the Internet 50. The communication unit 100 receives from the timer 154 current time information which indicates a current time, at the time that the e-mail is received. The communication unit 100 attaches the current time information to the received e-mail as receipt time information which indicates the time when the e-mail is received. The communication unit 100 sends the received e-mail to the judging unit 102.

The judging unit 102 receives the e-mail from the communication unit 100 and determines whether the source address of the received e-mail is included in the mail addresses stored in the address storing unit 120. The judging unit 102 generates judging result information which indicates whether the source address of the e-mail is included in the mail addresses stored in the address storing unit 120, and sends the judging result information to the received mail classification unit 110 together with the e-mail.

The received mail classification unit 110 classifies the e-mail received from the judging unit 102 based on the judging result information. The received mail classification unit 110 stores the e-mail received from the judging unit 102 in the second storing unit 130, in a case where the received mail classification unit 110 receives the judging result information which indicates that the source address of the e-mail is included in the mail addresses stored in the address storing unit 120. On the other hand, the received mail classification unit 110 stores the e-mail received from the judging unit 102 in the first storing unit 140, in a case where the received mail classification unit 110 receives the judging result information which indicates that the source address of the e-mail is not included in the mail addresses stored in the address storing unit 120.

The transmitting condition judging unit 156 determines whether a part of the e-mail stored in the first storing unit 140 is to be transmitted to the destination terminal 20. The transmitting condition judging unit 156 determines whether the number of e-mails containing the same source address among the e-mails stored in the first storing unit 140 is more than the value which is indicated in the count condition information stored in the transmitting condition storing unit 152. The transmitting condition judging unit 156 computes an elapsed time which has elapsed after the communication unit 100 received the e-mail stored in the first storing unit 140 by subtracting the receipt time information attached to the e-mail stored in the first storing unit 140 from the current time information received from the timer 154. The transmitting condition judging unit 156 determines whether the elapsed time is longer than a period which is indicated in the time condition information.

The transmitting condition judging unit 156 determines that transmitting condition is satisfied, in a case where the number of the e-mails containing the same source address stored in the first storing unit 140 is more than the value indicated in the count condition information stored in the transmitting condition storing unit 152, or in a case where it has elapsed longer period than a period indicated in the time condition information after the communication unit 100 received the e-mail stored in the first storing unit 140. The transmitting condition judging unit 156 sends a part of the e-mail which satisfies the transmitting condition to the transmitting unit 150.

The transmitting unit 150 reads the e-mail stored in the second storing unit 130. The transmitting unit 150 transmits the read e-mail to the destination terminal 20. The transmitting unit 150 transmits a part of the e-mail received from the transmitting condition judging unit 156 to the destination terminal 20. Apart of the e-mail is, for example, a source address of the e-mail, a subject of the e-mail, an amount of data of the e-mail, text of the e-mail, or a part of the text of the e-mail. The transmitting unit 150 transmits the source address of a plurality of e-mails containing the same source address, and count information, which indicates the number of the plurality of e-mails containing the same source address, to the destination terminal 20, in a case where the plurality of e-mails, which contain the same source address, are stored in the first storing unit 140.

The receiving unit 160 receives the instruction information which instructs whether each of whole part of the e-mail, a part of which is transmitted by the transmitting unit 150, is to be transmitted to the destination terminal 20, or to be deleted one by one, from the destination terminal 20. The receiving unit 160 sends the received instruction information to the e-mail processing unit 170. In a case where the instruction information instructs to delete whole part of the e-mail, a part of which is transmitted by the transmitting unit 150, the e-mail processing unit 170 reads the source address of the e-mail, corresponding to the instruction information, which is transmitted by the transmitting unit 150. The e-mail processing unit 170 sends the read source address to the e-mail composition unit 180. The e-mail composition unit 180 composes an undeliverable message, which indicates that the mail address owned by the destination terminal 20 does not exist, for the source address received from the e-mail processing unit 170, and sends the message to the communication unit 100. The communication unit 100 transmits the undeliverable message received from the e-mail composition unit 180 to the source terminal 30 through the Internet 50 and the source mail server 40 by e-mail. The e-mail processing unit 170 deletes whole part of the e-mail, which corresponds to the instruction information, from the first storing unit 140.

In a case where the instruction information instructs to transmit whole part of the e-mail, a part of which is transmitted by the transmitting unit 150, the e-mail processing unit 170 sends the instruction information to the transmitting unit 150. The transmitting unit 150 reads whole part of the e-mail, a part of which is transmitted by the transmitting unit 150, from the first storing unit 140, in a case where the transmitting unit 150 receives the instruction information which instructs to transmit whole part of the e-mail, a part of which is transmitted by the transmitting unit 150. The transmitting unit 150 transmits whole part of the read e-mail to the destination terminal 20.

By the foregoing operation, the mail server 10 transmits the e-mail to the destination terminal 20 in a case where a user of the destination terminal 20 requests for reading of the e-mail, or deletes the e-mail in a case where the user of the destination terminal 20 requests for deleting of the e-mail.

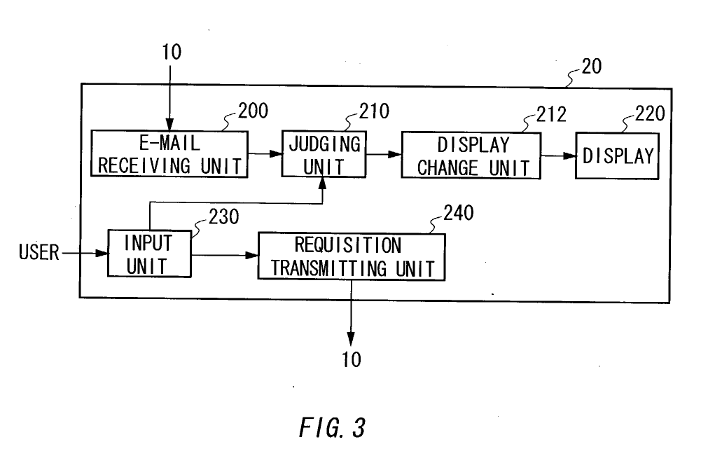

FIG. 3 is a block diagram showing a functional configuration of the destination terminal 20 of the present embodiment. The destination terminal 20 has an e-mail receiving unit 200, a judging unit 210, a display change unit 212, a display 220, an input unit 230, and a requisition transmitting unit 240.

The e-mail receiving unit 200 receives complete e-mail or partial e-mail from the mail server 10. Thee-mail receiving unit 200 sends the received complete e-mail or the received partial e-mail to the judging unit 210.

The judging unit 210 determines whether the information received from the e-mail receiving unit 200 is complete e-mail, or partial e-mail. The judging unit 210 sends judging result information, which indicates whether the information received from the e-mail receiving unit 200 is the complete e-mail, or the partial e-mail, to the display change unit 212.

The display change unit 212 composes a list of e-mails based on the received complete e-mails and the received partial e-mails. The list of e-mails contains, for example, source addresses of the complete e-mails and the partial e-mails. The display change unit 212 attaches identification information to the position corresponding to the partial e-mails on the list of e-mails based on the judging result information so as to distinguish the partial e-mails from the complete e-mails. The display change unit 212 sends the composed list of e-mails to the display 220.

Although the destination terminal 20 of the present embodiment determines whether the information received by the e-mail receiving unit 200 is partial e-mail, the destination terminal 20 may receive partial e-mail with identification information, which indicates that it is partial e-mail, from the mail server 10 as an alternative example. In this example, the mail server 10 transmits the partial e-mail with the identification information, which indicates that it is partial e-mail.

The display 220 displays the e-mails and the list of the e-mails received from the display change unit 212. The input unit 230 receives e-mail selection information which indicates that complete e-mail or partial e-mail displayed on the display 220 is to be selected, from the user of the destination terminal 20.

The input unit 230 sends display instruction information, which indicates that the e-mail selected by the user is to be displayed, to the judging unit 210, in a case where the input unit 230 receives the e-mail selection information. The judging unit 210 sends the complete e-mail or the partial e-mail selected by the user to the display change unit 212 based on the display instruction information.

The display change unit 212 sends whole part of the received e-mail to the display 220, in a case where the complete e-mail selected by the user is received. The display 220 displays whole part of the received e-mail. In a case where the partial e-mail selected by the user is received, the display change unit 212 sends an inquiry screen to the display 220 to inquire the user about a determination whether whole part of the e-mail corresponding to the received partial e-mail is to be received or to be deleted. The display 220 displays the received inquiry screen. The input unit 230 sends the instruction information from the user, which indicates that the e-mail selected by the user is to be displayed or to be deleted, to the requisition transmitting unit 240. The requisition transmitting unit 240 transmits the received instruction information to the mail server 10.

In the first storing unit 140, the mail server 10 deletes whole part of the e-mail, or transmits the e-mail to the destination terminal 20, the e-mail corresponding to the instruction information, based on the instruction information received from the destination terminal 20.

The e-mail receiving unit 200 receives whole part of the e-mail from the mail server 10. The e-mail receiving unit 200 sends whole part of the received e-mail to the display change unit 212 through the judging unit 210. The display change unit 212 sends whole part of the received e-mail to the display 220. The display 220 displays whole part of the received e-mail.

The destination terminal 20 receives the e-mails from the mail server 10 and displays the e-mails, which the user of the destination terminal 20 requests for reading, among the received e-mails, on the display 220.

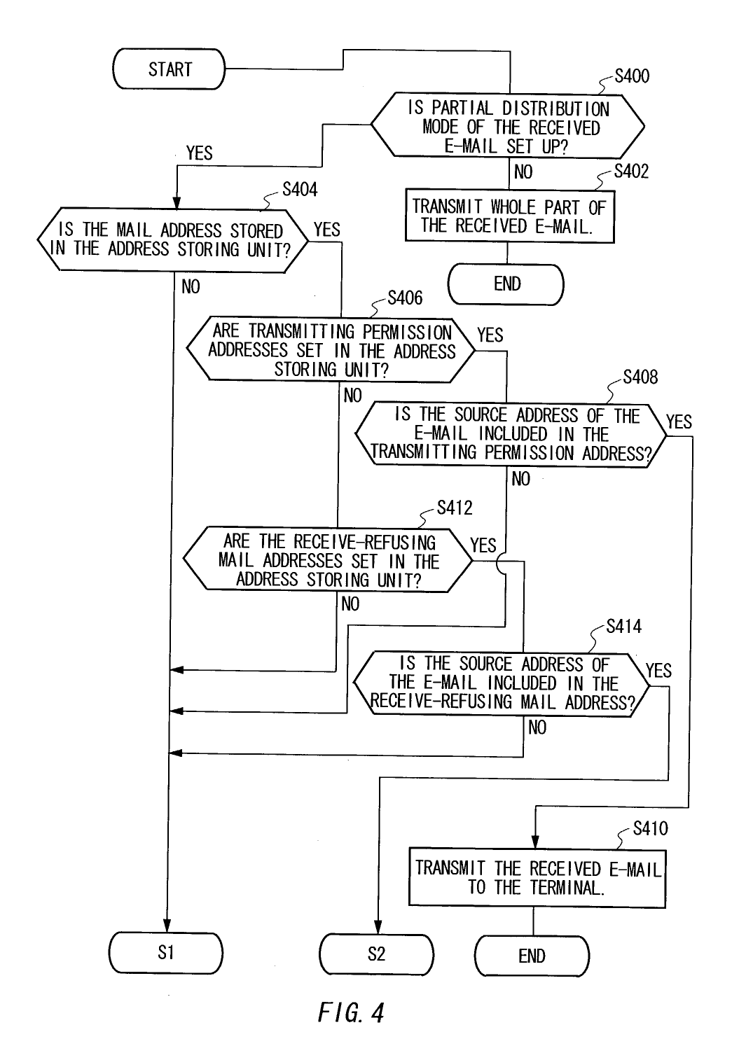

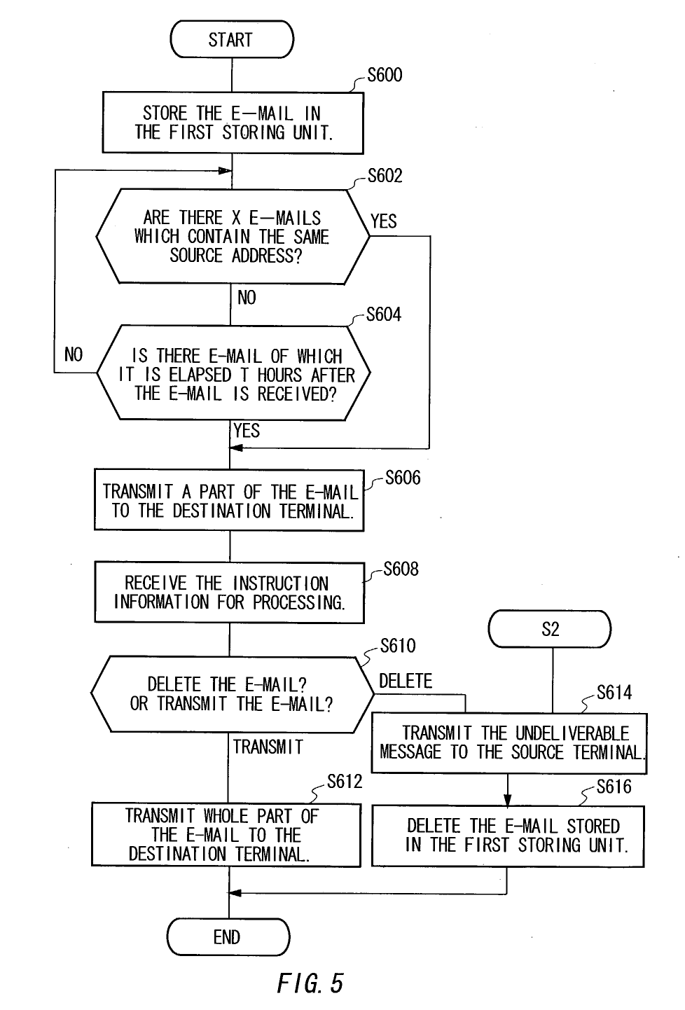

FIG. 4 is a flow chart indicating operation of the mail server 10 of the present embodiment at the time of receiving the e-mail. The mail server 10 determines whether a partial distribution mode, which transmits the received partial e-mail to a terminal 20, is set up (Step S400). In a case where the partial distribution mode is not set up, the transmitting unit 150 transmits whole part of the received e-mail to the terminal 20 (Step S402). In a case where the partial distribution mode is set up, the judging unit 102 determines whether the mail address is stored in the address storing unit 120 (Step S404). In a case where the mail address is not stored in the address storing unit 120, a process shown in FIG. 5 is executed. In a case where the mail address is stored in the address storing unit 120, the judging unit 102 determines whether the transmitting permission addresses are set in the address storing unit 120 (Step S406). In a case where the judging unit 102 determines that the transmitting permission addresses are set in the address storing unit 120, the judging unit 102 determines whether the source address of the e-mail, received by the communication unit 100, is included in the transmitting permission addresses stored in the address storing unit 120 (Step S408). In a case where the judging unit 102 determines that the source address of the e-mail, received by the communication unit 100, is included in the transmitting permission addresses stored in the address storing unit 120, the transmitting unit 150 transmits whole part of the received e-mail to the terminal 20 (Step S410).

Then the sequence returns to Step S406. In a case where the judging unit 102 determines that the transmitting permission addresses are not set in the address storing unit 120, the judging unit 102 determines whether the receive-refusing mail addresses are set in the address storing unit 120 (Step S412). In a case where the judging unit 102 determines that the receive-refusing mail addresses are not set in the address storing unit 120, the process shown in FIG. 5 is executed. In a case where the judging unit 102 determines that the receive-refusing mail addresses are set in the address storing unit 120, the judging unit 102 determines whether the source address of the e-mail, received by the communication unit 100, is included in the receive-refusing mail addresses stored in the address storing unit 120 (Step S414). In a case where the judging unit 102 determines that the source address of the e-mail, received by the communication unit 100, is not included in the receive-refusing mail addresses stored in the address storing unit 120, the process shown in FIG. 5 is executed. In a case where the judging unit 102 determines that the source address of the e-mail, received by the communication unit 100, is included in the receive-refusing mail addresses stored in the address storing unit 120, the process shown in FIG. 5 is executed.

FIG. 5 is a continuation flow chart of the flow chart shown in FIG. 4. The received mail classification unit 110 stores the e-mail, received by the communication unit 100, in the first storing unit 140 (Step S600). Then the transmitting condition judging unit 156 determines whether the number of the e-mails, which contain the same source address, stored in the first storing unit 140, are more than the predetermined value indicated in the count condition information (Step S602). In a case where the transmitting condition judging unit 156 determines that the number of the e-mails, which contain the same source address stored in the first storing unit 140, is less than the value indicated in the count condition information, the transmitting condition judging unit 156 determines whether there is the e-mail in the first storing unit 140, where the elapsed time after the communication unit 100 received the e-mail is longer than the period indicated in the time condition information (Step S604). In a case where the transmitting condition judging unit 156 determines that there is no e-mail in the first storing unit 140, where the elapsed time after the communication unit 100 received the e-mail is longer than the period indicated in the time condition information, the sequence returns to Step S412. In a case where the number of the e-mails, which contains the same source address, is more than the value indicated in the count condition information in Step S412, or in a case where there is the e-mail, where the elapsed time after the communication unit 100 received the e-mail is longer than the period indicated in the time condition information, in Step S414, the transmitting unit 150 transmits a part of the e-mail stored in the first storing unit 140 to the terminal 20 (Step S606).

The receiving unit 160 receives the instruction information indicating how to process whole part of the e-mail, a part of which is transmitted to the destination terminal 20 by the transmitting unit 150, from the destination terminal 20 by which a part of the e-mail is received (Step S608). Then the e-mail processing unit 170 determines whether the instruction information instructs to delete the e-mail corresponding to instruction information, or to transmit the e-mail to the destination terminal 20 (Step S610). In a case where the instruction information received by the receiving unit 160 instructs to delete the e-mail, the e-mail composition unit 180 composes an undeliverable message, which indicates that the mail address owned by the destination terminal 20 does not exist. The communication unit 100 transmits the undeliverable message to the source address which corresponds to the instruction information by e-mail (Step S614). In a case where the instruction information received by the receiving unit 160 instructs to delete the e-mail, the e-mail process unit 170 deletes the e-mail, which corresponds to the instruction information, stored in the first storing unit 140 (Step S616). In a case where the instruction information received by the receiving unit 160 instructs to receive the e-mail, the transmitting unit 150 transmits whole part of the e-mail, which corresponds to the instruction information, stored in the first storing unit 140 to the destination terminal 20 (Step S612).

According to the foregoing operation, the mail server 10 classifies the received e-mail based on the source address, and transmits the e-mail, which the user of the destination terminal 20 requests for reading, to the destination terminal 20.

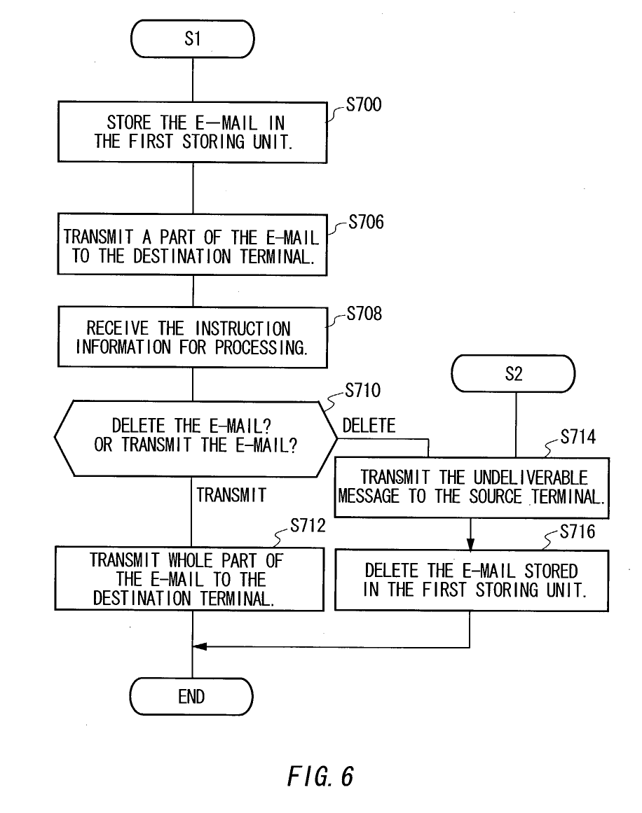

FIG. 6 is another example of a continuation flow chart of the flow chart shown in FIG. 4, which is different from the FIG. 5. In a case where the transmitting condition judging unit 156 determines that there is no e-mail in the first storing unit 140, where the elapsed time after the communication unit 100 received the e-mail is longer than the period indicated in the time condition information, the sequence returns to Step S412. In a case where the number of the e-mails which contain the same source address are more than the value indicated in the count condition information in Step S412, or in a case where there is e-mail, where the elapsed time after the communication unit 100 received the e-mail is longer than the period indicated in the time condition information, in Step 414, the transmitting unit 150 transmits a part of the e-mail stored in the first storing unit 140 to the destination terminal 20 (Step S706).

The receiving unit 160 receives the instruction information indicating how to process whole part of the e-mail, a part of which is transmitted to the destination terminal 20 by the transmitting unit 150, from the destination terminal 20 by which a part of the e-mail is received (Step S708). Then the e-mail processing unit 170 determines whether the instruction information instructs to delete the e-mail corresponding to instruction information, or to transmit the e-mail to the destination terminal 20 (Step S710). In a case where the instruction information received by the receiving unit 160 instructs to delete the e-mail, the e-mail composition unit 180 composes an undeliverable message, which indicates that the mail address owned by the destination terminal 20 does not exist. The communication unit 100 transmits the undeliverable message to the source address which corresponds to the instruction information by e-mail (Step S714). In a case where the instruction information received by the receiving unit 160 instructs to delete the e-mail, the e-mail process unit 170 deletes the e-mail, which corresponds to the instruction information, stored in the first storing unit 140 (Step S716). In a case where the instruction information received by the receiving unit 160 instructs to receive the e-mail, the transmitting unit 150 transmits whole part of the e-mail, which corresponds to the instruction information, stored in the first storing unit 140 to the destination terminal 20 (Step S712).

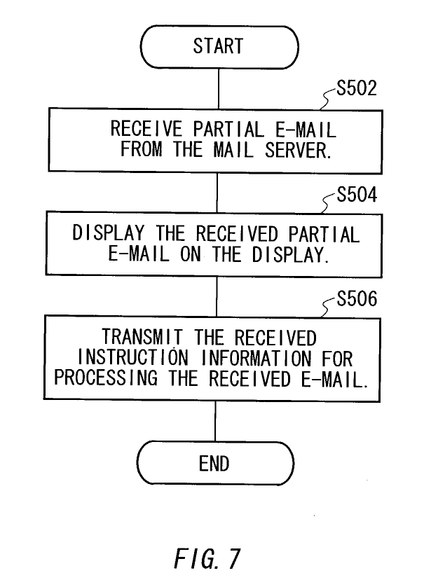

FIG. 7 is a flow chart indicating operation of the destination terminal 20 according to the present embodiment. The e-mail receiving unit 200 receives partial e-mail from the mail server 10 (Step S502). Then the display 220 displays the partial e-mail received by the e-mail receiving unit 200 on the display 220 (Step S504). Then the input unit 230 receives the instruction information from the user, the instruction information indicating whether whole part of the partial e-mail received by the e-mail receiving unit 200 is to be received, or to be deleted. The requisition transmitting unit 240 transmits the instruction information received by the input unit 230 to the mail server 10 (Step S506). In a case where the input unit 230 receives the instruction information, which instructs to receive whole part of the partial e-mail received by the e-mail receiving unit 200, from the user of the destination terminal 20, the e-mail receiving unit 200 receives whole part of the e-mail corresponding to the instruction information which instructs to receive whole part of the e-mail from the mail server. The display 220 displays whole part of the e-mail corresponding to the instruction information which instructs to receive whole part of the e-mail.

By the foregoing operation, the destination terminal 20 receives the e-mail, which the user of the destination terminal 20 requests for reading, from the mail server 10, and displays the e-mail on the display 220.

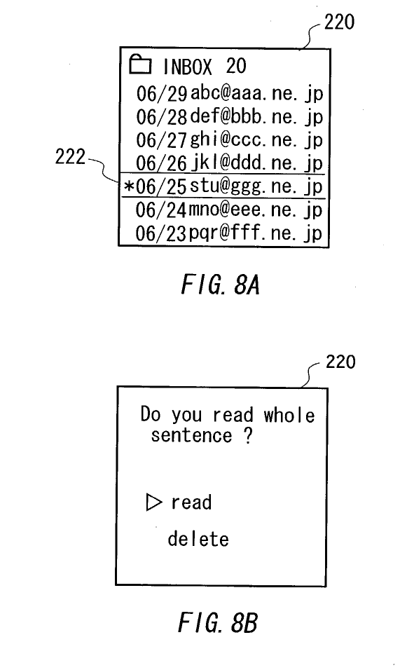

FIG. 8 shows an example of a screen which the display 220 of the destination terminal 20 of the present embodiment displays. FIG. 8A shows an example of the screen which the display 220 displays in Step S504 of FIG. 5. The display 220 displays a list of the complete e-mails and the partial e-mails received by the e-mail receiving unit 200 from the mail server 10. In a case where e-mail (partial e-mail) 222, which is transmitted by the mail server 10, is displayed on the list, identification information, which indicates that the e-mail 222 is partial e-mail, is attached to the e-mail 222. The identification information, which indicates partial e-mail, is for example, a mark “*”. The user of the destination terminal 20 may select the e-mail 222, which the user requests for reading, from the screen shown in FIG. 8A by inputting the selection information, which selects the e-mail, which the user requests for reading, to the input unit 230.

FIG. 8B shows an example of a screen which the display 220 displays in Step S506 shown in FIG. 8. In a case where the user of the destination terminal 20 selects the e-mail 222, which is partial e-mail, the display 220 displays the request for instructions how to process the e-mail 222. In a case where the user of the destination terminal 20 inputs the instructions into the input unit 230 to read whole part of the e-mail 222, the requisition transmitting unit 240 transmits the instruction information which requests transmission of whole part of the e-mail 222 to the mail server 10. In a case where the user instructs to delete the e-mail 222, the requisition transmitting unit 240 transmits the instruction information to the mail server 10 to delete the e-mail 222.

By the foregoing operation, the user of the destination terminal 20 selects and reads the e-mail which the user requests for reading.

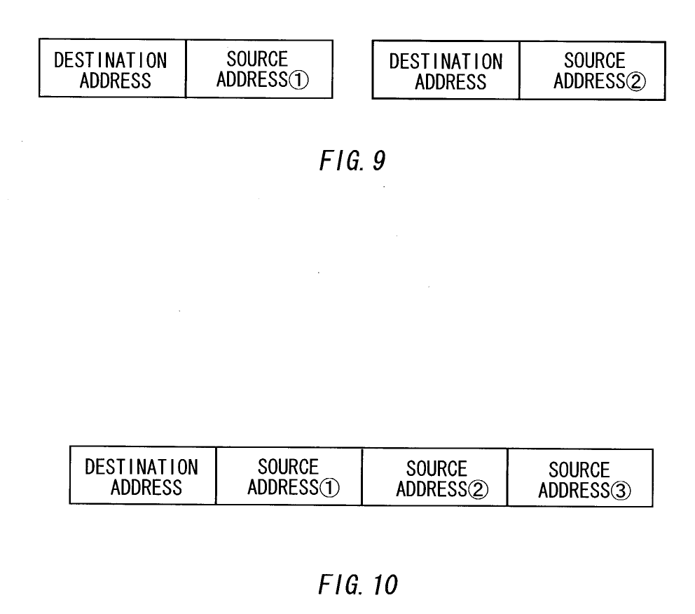

FIG. 9 is an example of contents of information when a conventional mail server transmits a plurality of e-mails to a terminal. FIG. 10 is an example of contents of information when the mail server 10 of the present embodiment transmits a plurality of e-mails collectively to the terminal 20. The conventional mail server attaches a source address of the e-mail and a destination address of the e-mail to each of the plurality of e-mails, and transmits them to the terminal. On the other hand, the mail server 10 of the present embodiment attaches a plurality of source addresses of the e-mail, and one destination address to information which bundles the plurality of e-mails, and transmits it to the terminal 20. In this fashion, the mail server 10 reduces amount of information transmitted to the terminal 20.

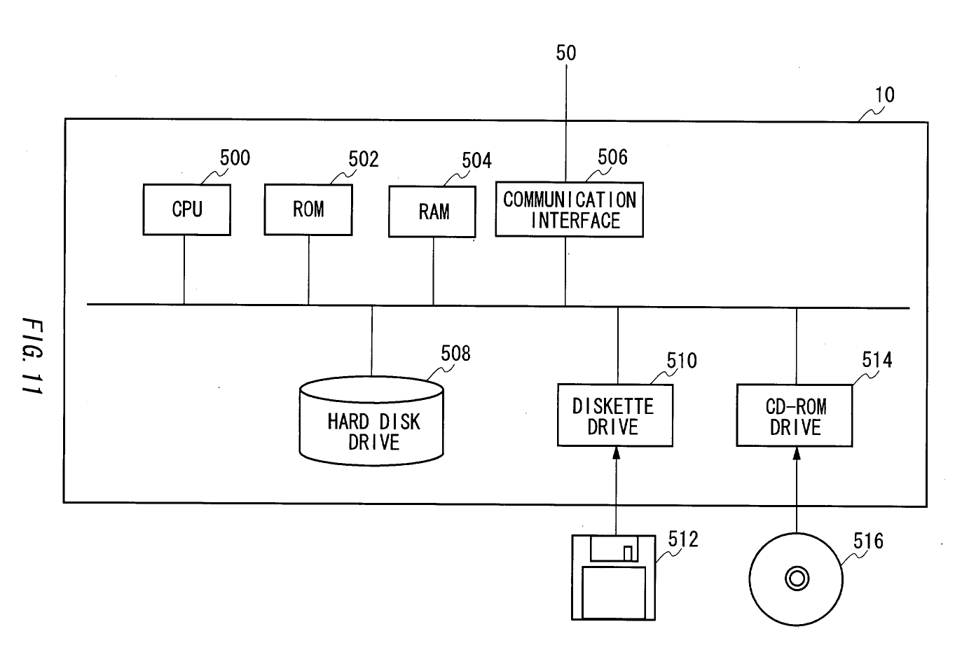

FIG. 11 is a block diagram showing a hardware configuration of the mail server 10. The mail server 10 includes CPU 500, ROM 502 and RAM 504, and a communication interface 506. CPU 500 works based on a program stored in the ROM 502 and the RAM 504. The communication interface 506 communicates with outside through the Internet 50. Hard disk drive 508 as an example of storage stores setting information and the program with which the CPU 500 works.

Diskette drive 510 reads data or a program in a diskette 512, and provides the CPU 500 with it. CD-ROM drive 514 reads data or a program in CD-ROM 516, and provides the CPU 500 with it. The communication interface 506 transmits and receives data through the Internet 50.

The software executed by the CPU 500 is stored in a record medium such as the diskette 514 or the CD-ROM 516, and provided to the user. Either compressed or decompressed software is applicable as the software stored in the record medium. The software is installed in the hard disk drive 508 from the record medium. The installed software is read by the RAM 504 and executed by the CPU 500.

The software which is stored in the record medium and provided, i.e., the software installed in the hard disk drive 508, includes a judging module, a received mail classification module, a timer module, a transmitting condition judging module, an e-mail processing module, and an e-mail composition module as a functional configuration. Since process, which each of these modules makes the CPU 500 of the computer execute, is the same as the function and the operation of the corresponding component in the mail server 10 in the present embodiment, the explanation of these modules is omitted.

Some or all functions of operation of the mail server 10 in all the embodiments explained in this patent application are storable in the diskette 512 or the CD-ROM 516 as examples of record media shown in FIG. 11.

These programs may be read from the record medium by the RAM 504 directly and executed, or the programs may be installed in the hard disk drive 508 once and then be read by the RAM 504 and executed. Furthermore, the programs may be stored in a single record medium or a plurality of record media. The modules stored in the record medium may provide each function in cooperation with an operating system. For example, the operating system may be requested to do some or all functions, and the function may be provided based on the response from the operating system.

As a record medium, an optical record medium such as DVD or PD, a magneto-optical record medium such as Minidisk, a tape medium, a magnetic record medium, semiconductor memory such as an IC card or a miniature card, or the like may be used other than a diskette or CD-ROM. Storage, such as a hard disk or RAM prepared in a server system connected to a dedicated communication network or the Internet, may be used as a record medium, and the program may be provided to the mail server 10 through the communication network.

By the foregoing hardware configuration, each operation shown in the present embodiment is performed by the mail server 10.

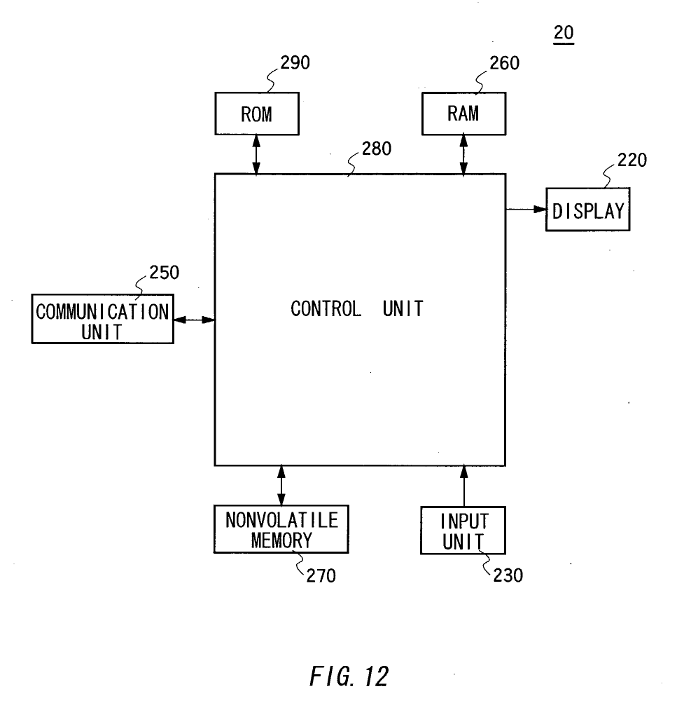

FIG. 12 is a block diagram showing a hardware configuration of the destination terminal 20 in the present embodiment. The destination terminal 20 includes a communication unit 250, ROM 290, RAM 260, nonvolatile memory 270, a control unit 280, the input unit 230, and the display 220.

The communication unit 250 outputs the complete e-mail or the partial e-mail received from the outside through the communication network, to the control unit 280. The ROM 290 stores a control program of the destination terminal 20, for example. The RAM 260 stores various setting information or the like, for example. That is, the RAM 260 stores a message of a title and a message of a text of the e-mail inputted by the user. The nonvolatile memory 270 stores address information or the like, for example, in addition to the received e-mail.

The control unit 280 performs communication control, signal transmission processing or the like of the destination terminal 20 using the program and the data stored in the ROM 290, the RAM 260, the nonvolatile memory 270 or the like. Especially the function of each functional block explained in FIG. 3 is performed by the control unit 280 with the communication unit 250, the ROM 290, the RAM 260, the nonvolatile memory 270, and the input unit 110.

The program, which the control unit 280 uses during the processing, that is, the program stored in predetermined area of the ROM 290, the RAM 260 and the nonvolatile memory 270 includes an e-mail receiving module, a judging module and a display change module. These program modules are programs by which each function of the e-mail receiving unit and the judging unit is performed, respectively. In this example, although these program modules are stored in the RAM 260 or the like, these programs modules may be provided to the destination terminal 20 through removable media, a radio communication network, or the like.

The input unit 230 outputs information inputted by the user to the control unit 280. The information inputted by the user is, for example, the information of a selection input to choose the complete e-mail or the partial e-mail received by the communication unit 250, and to display the e-mail on the display 220. The input unit 230 receives the input of information, such as the selection input, and outputs it to the control unit 280. A picture is displayed on the display 220 based on the image information received from the control unit 280. The display 220 is a LCD, for example.

By the foregoing hardware configuration, each operation shown in the present embodiment is performed by the destination terminal 20.

A modified example of the present embodiment is explained. In the present embodiment, although the received mail classification unit 110 stores the received e-mail in the second storing unit 130 in a case where the source address of the received e-mail is included in the mail addresses stored in the address storing unit 120, alternatively, the received mail classification unit 110 may store the received e-mail in the first storing unit 140 in a case where the source address of the received e-mail is included in the mail addresses stored in the address storing unit 120. In this example, the received mail classification unit 110 stores the e-mail in the second storing unit 130 in a case where source address of the received e-mail is not included in the mail addresses stored in the address storing unit 120.

In this example, the mail server 10 reduces amount of data transmitted to the destination terminal 20 from the mail server 10, in a case where transmitting the plurality of complete e-mails or partial e-mails which have the different source addresses.

By the foregoing operation, the mail server 10 reduces amount of data transmitted to the destination terminal 20 from the mail server 10.

As is obvious from the foregoing description, amount of information of communication between the mail server 10 and the destination terminal 20 which receives the e-mail from the mail server 10 is reduced.

Although the present invention has been described by way of exemplary embodiment, the scope of the present invention is not limited to the foregoing embodiment. Various modifications in the foregoing embodiment may be made when the present invention defined in the appended claims is enforced. It is obvious from the definition of the appended claims that embodiments with such modifications also belong to the scope of the present invention.

What is claimed is:

1. A mail server which transmits e-mail to a terminal, comprising:
a communication unit which receives e-mail from the outside through a communication network;
a first storing unit which stores the e-mail;
a transmitting unit which transmits a part of the e-mail stored in said first storing unit to a terminal which is a destination of the e-mail;
a receiving unit which receives instruction information from the terminal, the instruction information indicating whether whole part of the e-mail, a part of which is transmitted to the terminal by said transmitting unit, is to be transmitted or to be deleted; and
an e-mail processing unit which transmits or deletes the e-mail stored in said e-mail storing unit based on the instruction information when said receiving unit receives the instruction information from the terminal.

2. The mail server as claimed in claim 1, wherein said transmitting unit transmits a part of the e-mail to the terminal when number of the e-mails stored in said first storing unit is more than predetermined value, or when a predetermined period has elapsed after the e-mail is stored in said first storing unit.

3. The mail server as claimed in claim 1,
wherein said transmitting unit transmits a source address of the e-mail to the terminal as a part of the e-mail, and
said e-mail processing unit transmits whole part of the e-mail, a part of which is transmitted to the terminal by said transmitting unit, to the terminal when the instruction information indicates that the e-mail, which includes the source address transmitted by said transmitting unit, is to be transmitted, and deletes the e-mail when the instruction information indicates that the e-mail is to be deleted.

4. The mail server as claimed in claim 1,
wherein said transmitting unit transmits a part of the e-mail to the terminal when number of the e-mails stored in said first storing unit is more than predetermined value, or when a predetermined period has elapsed after the e-mail is stored in said first storing unit,
said transmitting unit further transmits a source address of the e-mail to the terminal as a part of the e-mail, and
said e-mail processing unit transmits whole part of the e-mail, a part of which is transmitted to the terminal by said transmitting unit, to the terminal when the instruction information indicates that the e-mail, which includes the source address transmitted by said transmitting unit, is to be transmitted, and deletes the e-mail when the instruction information indicates that the e-mail is to be deleted.

5. The mail server as claimed in claim 1, further comprising an e-mail composition unit which composes an undeliverable message which indicates that a destination address of the terminal does not exist, for a source terminal which is a source of the e-mail when said receiving unit receives the instruction information, which indicates that the e-mail is to be deleted, from the terminal,
wherein said communication unit transmits the undeliverable message to the source terminal by e-mail.

6. The mail server as claimed in claim 1,
wherein said transmitting unit transmits a part of the e-mail to the terminal when number of the e-mails stored in said first storing unit is more than predetermined value, or when a predetermined period has elapsed after the e-mail is stored in said first storing unit, and further comprising
an e-mail composition unit which composes an undeliverable message which indicates that a destination address of the terminal does not exist, for a source terminal which is a source of the e-mail when said receiving unit receives the instruction information, which indicates that the e-mail is to be deleted, from the terminal,
wherein said communication unit transmits the undeliverable message to the source terminal by e-mail.

7. wherein said transmitting unit transmits a source address of the e-mail to the terminal as a part of the e-mail,
said e-mail processing unit transmits whole part of the e-mail, a part of which is transmitted to the terminal by said transmitting unit, to the terminal when the instruction information indicates that the e-mail, which includes the source address transmitted by said transmitting unit, is to be transmitted, and deletes the e-mail when the instruction information indicates that the e-mail is to be deleted, and further comprising
an e-mail composition unit which composes an undeliverable message which indicates that a destination address of the terminal does not exist, for a source terminal which is a source of the e-mail when said receiving unit receives the instruction information, which indicates that the e-mail is to be deleted, from the terminal,
wherein said communication unit transmits the undeliverable message to the source terminal by e-mail.

8. The mail server as claimed in claim 1,
wherein said transmitting unit transmits a part of the e-mail to the terminal when number of the e-mails stored in said first storing unit is more than predetermined value, or when a predetermined period has elapsed after the e-mail is stored in said first storing unit,
said transmitting unit further transmits a source address of the e-mail to the terminal as a part of the e-mail,
said e-mail processing unit transmits whole part of the e-mail, a part of which is transmitted to the terminal by said transmitting unit, to the terminal when the instruction information indicates that the e-mail, which includes the source address transmitted by said transmitting unit, is to be transmitted, and deletes the e-mail when the instruction information indicates that the e-mail is to be deleted, and further comprising
an e-mail composition unit which composes an undeliverable message which indicates that a destination address of the terminal does not exist, for a source terminal which is a source of the e-mail when said receiving unit receives the instruction information, which indicates that the e-mail is to be deleted, from the terminal,
wherein said communication unit transmits the undeliverable message to the source terminal by e-mail.

9. A mail server which transmits e-mail to a terminal, comprising:
an address storing unit which stores a part of or whole part of mail addresses;
a communication unit which receives e-mail from the outside through a communication network;
a first storing unit which stores the e-mail;
a judging unit which determines whether a source address of the e-mail received by said communication unit from the outside is included in the mail addresses stored in said address storing unit; and
a received mail classification unit which stores the e-mail, of which the source address is not included in the mail addresses stored in said address storing unit, in said first storing unit;
wherein said transmitting unit transmits a part of the e-mail, in which the source address classified by said received mail classification unit is not included in said mail addresses, to the terminal which is destination of the e-mail.

10. The mail server as claimed in claim 2, wherein said transmitting unit transmits a part of the e-mail to the terminal when number of the e-mails stored in said first storing unit is more than predetermined value, or when a predetermined period has elapsed after the e-mail is stored in said first storing unit.

11. The mail server as claimed in claim 2,
wherein said transmitting unit transmits a source address of the e-mail to the terminal as a part of the e-mail, and
said e-mail processing unit transmits whole part of the e-mail, a part of which is transmitted to the terminal by said transmitting unit, to the terminal when the instruction information indicates that the e-mail, which includes the source address transmitted by said transmitting unit, is to be transmitted, and deletes the e-mail when the instruction information indicates that the e-mail is to be deleted.

12. The mail server as claimed in claim 2,
wherein said transmitting unit transmits a part of the e-mail to the terminal when number of the e-mails stored in said first storing unit is more than predetermined value, or when a predetermined period has elapsed after the e-mail is stored in said first storing unit,
said transmitting unit further transmits a source address of the e-mail to the terminal as a part of the e-mail, and
said e-mail processing unit transmits whole part of the e-mail, a part of which is transmitted to the terminal by said transmitting unit, to the terminal when the instruction information indicates that the e-mail, which includes the source address transmitted by said transmitting unit, is to be transmitted, and deletes the e-mail when the instruction information indicates that the e-mail is to be deleted.

13. An e-mail system which transmits and receives e-mail, comprising:
a terminal which sends and receives e-mail; and
a mail server which receives e-mail from the outside, processes the received e-mail, and transmits a part of the received e-mail to said terminal.

14. The e-mail system as claimed in claim 13, wherein said terminal transmits an instruction information to said mail server based on information of the part of the e-mail, the instruction information indicating whether the whole part of the e-mail, a part of which is transmitted to said terminal, is to be transmitted to said terminal or to be deleted.

15. The e-mail system as claimed in claim 14, wherein said mail server transmits the e-mail to said terminal or deletes the e-mail based on the instruction information from said terminal.

16. A terminal which transmits and receives e-mail, comprising:
an e-mail receiving unit which receives a part of e-mail, which is received from the outside by a mail server; and
a requisition transmitting unit which transmits an instruction information to the mail server based on information of the part of the e-mail, the instruction information indicating whether whole part of the e-mail, a part of which is received by said receiving unit, is to be transmitted to said receiving unit or to be deleted.

17. The terminal as claimed in claim 16, wherein said e-mail receiving unit receives the e-mail from the mail server when said requisition transmitting unit transmits the instruction information to the mail server, the instruction information indicating whole part of the e-mail, a part of which is received by said receiving unit, is to be transmitted to said receiving unit.
